(19) United States
(12) Patent Application Publication
(10) Pub. No.: US 2025/0251544 A1
(43) Pub. Date: Aug. 7, 2025

(54) MULTI-CORE FIBER AND METHOD OF FABRICATION THEREOF

(71) Applicant: COGNIFIBER LTD., Rosh Ha’Ayin (IL)

(72) Inventors: Eyal COHEN, Gedera (IL); Zeev ZALEVSKY, Rosh Ha'Ayin (IL); Maya YEVNIN, Tel Aviv (IL)

(21) Appl. No.: 18/859,667

(22) PCT Filed: May 29, 2023
(86) PCT No.: PCT/IL2023/050550

§ 371 Date: Oct. 24, 2024

Related U.S. Application Data
(60) Provisional application No. 63/347,211, filed on May 31, 2022.

(51) Int. Cl. G02B 6/02; B29D 11/00

(52) U.S. Cl. CPC G02B 6/02042; B29D 11/00721

(57) ABSTRACT

A method is presented for fabricating a multi-core fiber of a complex geometry. A plurality of N initial optical packages is provided, each optical package having an initial cross-sectional dimension a and including a predetermined number M of optical guiding units. This N optical packages are bundled into a bundle structure, and this bundle structure undergoes heating-based treatment to compress it and obtain a new multicore fiber having a cross-sectional dimension c being equal or smaller than the initial cross-sectional dimension a and including a number N×M cores.

### TECHNOLOGICAL FIELD AND BACKGROUND

The present disclosure relates to multicore optical fibers and method of their manufacture. The technique of the present disclosure is particularly useful in optical computation devices, such as those used for artificial neural networks.

Multicore fiber (MCF) is increasingly of interest for various applications including high density coupling for photonic integrated circuits, space division multiplexing (SDM) of optical communication channels, artificial neural networks, and other in-fiber computation operation/tasks.

Various neural network configurations have been developed relying on light propagation and coupling between cores of a multicore fiber. For example, article “Neural networks within multi-core optic fibers”, Eyal Cohen et al., Scientific Reports, vol. 6, 7 Jul. 2016, pages 1-14, describes the use of multicore fibers for hardware implementation of artificial neural networks which facilitates real-time parallel processing of massive data sets. According to this technique, optical signals are transferred transversely between fiber cores by means of optical coupling.

Also, patent publication WO 2021064727, assigned to the assignee of the present application, teaches an artificial neuron network and corresponding neuron units based on the use of multicore fibers.

### GENERAL DESCRIPTION

In recent years there is an increase demand in the optical communication industry for various in-fiber operations. For this purpose, a complex fiber geometry is required. More specifically, multicore fibers with a high core count, and possibly selective core doping, are required to realize computational operations in fiber.

Thus, there is a need in the art for a novel technique enabling implementation of a multicore fiber with as large as possible number of cores while being arranged in as small as possible fiber diameter (generally, cross-sectional dimension).

As known, a multicore fiber includes multiple cores within a common cladding. In the description below, the term “size” or “lateral size” is used at times in relation to a cross-sectional dimension of the multicore fiber (i.e. of the cladding).

The present disclosure provides a novel method for fabrication of a multicore fiber of a complex geometry, i.e. a multicore fiber with high core count, which allows complex predesigned positioning of cores with different compositions.

The complex-geometry multicore fiber of the present disclosure is fabricated from several optical packages, each including a few (relatively low count, e.g. 3-19) optical guiding elements (waveguides). Such a package may be a simple low core count custom made multicore fiber, or a standard (commercially available) multicore fiber, or a bundle of polymer fiber or glass tubes or a hybrid configuration formed by polymer fibers and glass tubes.

The complex-geometry multicore fiber fabricated by the technique of the present disclosure from several (generally at least two) such packages has a significantly increased number of cores as compared to the number of optical guiding elements in the package (e.g. at least 3 times increase of the number of cores).

More specifically, the technique of the present disclosure utilizes a relatively low core count multicore fiber as the initial package of multiple optical guiding units and is therefore described below with respect to this application. However, the principles of the present disclosure are not limited to this specific example, and therefore the term “initial multicore fiber” used herein should be interpreted broadly as “initial package of multiple optical guiding units”, covering a low core count multicore fiber (being a single-mode fiber or multi-mode fiber), and also an optical package/bundle of optical guiding units such as polymer fibers and/or glass tubes.

As indicated above, various applications require the use of doped cores and, moreover, a multicore fiber in which only some of the cores are to be doped (e.g. a specific pattern of doped and passive cores is to be used). The process of doping of selected cores (i.e. addressing each core or selected cores individually) would be more complicated in a fiber with tight arrangement of cores. The method of the multicore fiber manufacture of the present disclosure is also particularly useful/advantageous for manufacture of such fibers where at least some of the cores are to be properly doped and possibly also with different levels of doping (i.e. when a desired pattern of doped cores is to be used), since the controlled doping of the cores is performed at the initial stage only (i.e. applied to initial, low core count, multicore fiber) and maintained during the process of fabricating the resulting high core count multicore fiber.

According to a broad aspect of the present disclosure, there is provided a method of fabricating a multi-core fiber having a complex geometry, the method comprising:
(i) providing a plurality of N initial optical packages, each optical package having an initial cross-sectional dimension a and including a plurality of M optical guiding units;
(ii) bundling said plurality of N optical packages into a bundle structure; and
(iii) applying a heating-based treatment to said bundle structure to obtain a new multicore fiber having a cross-sectional dimension c being equal or smaller than the initial cross-sectional dimension a and including a number N×M cores.

In some embodiments, the initial optical package is a bundle of polymer fibers and/or glass tubes including an array of M polymer fibers and/or glass tubes (constituting the optical guiding units). In some other embodiments, the initial optical package is an initial multicore fiber including an array of M cores (constituting the optical guiding units). Such initial multicore fiber may be a single-mode or multi-mode fiber. The bundle structure of N multicore bundles may include single-mode multicore fibers, multi-mode multicore fibers or a mixture of single-mode and multi-mode fibers.

In some embodiments, the method further comprises performing at least one repetition of successively performed processes (ii) and (ii) of the bundling and the heating-based treatment applied to a new plurality of a number K of the new multicore fibers, thereby obtaining a successive new multicore fiber including N×M×K cores.

In some embodiments, the plurality of N initial multicore fibers includes one or more multicore fibers having doped cores, e.g., a pattern of passive and doped cores.

It should also be noted that the multicore fibers can be fused by a more aggressive tapering into a multi-mode region, in which interaction occurs similarly to that of photonic lantern, i.e., adiabatically several single-mode cores into one multimode core, providing low-loss interfaces between single-mode and multimode systems. More specifically, this enables low-loss transformation of a multimode system into a discrete number of single-mode systems and vice versa.

The present disclosure in its another broad aspect provides a multicore fiber manufactured by the above-described method. Such multicore fiber may include at least cores and a cladding size of at least 50 microns. In some embodiments, a multicore fiber (fabricated by the above-described method) contains at least 30 or at least 40 cores.

The multicore fiber of the present disclosure presents an optical unit which can be used in various applications, i.e. as a part/functional block of an optical or electro-optical device, e.g., artificial neuron unit.

### BRIEF DESCRIPTION OF THE DRAWINGS

In order to better understand the subject matter that is disclosed herein and to exemplify how it may be carried out in practice, embodiments will now be described, by way of non-limiting examples only, with reference to the accompanying drawings, in which:

FIG. 1 schematically exemplifies a process for fabricating a multicore fiber of complex geometry according to the technique of the present disclosure; and

FIGS. 2A and 2B schematically illustrate two examples of the technique of the present disclosure for fabricating multi-core fibers of complex geometry, formed of passive cores (FIG. 2A) and formed by a pattern including passive and doped cores (FIG. 2B).

### DETAILED DESCRIPTION OF EMBODIMENTS

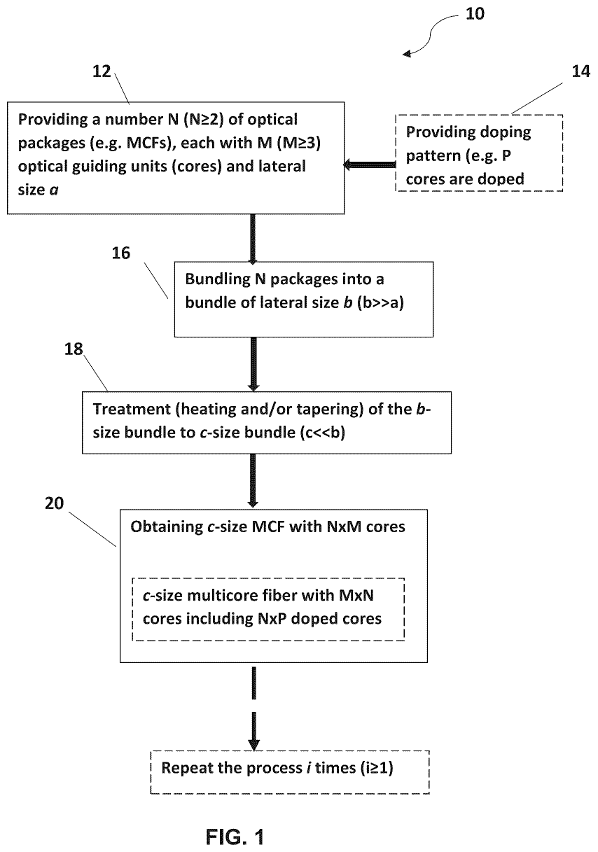

Reference is made to FIG. 1 illustrating a flow diagram 10 of a method of the present disclosure for fabricating multicore fibers of complex geometry. This method provides for obtaining at least 3 times increased number of cores within a multicore fiber as compared to a number of optical guiding units (e.g. cores) in an initial optical package of the guiding units (e.g. initial multicore fiber). The fabricated relatively high core count fiber can be of a cladding size (diameter) equal to or smaller than that of a given initial optical package of guiding units (e.g. initial multicore fiber).

As shown in the figure, the process starts from providing a plurality of N (N≥2) optical packages, e.g. low core count multicore fibers (step 12). These may be commercial or custom multicore fibers each with relatively low number of cores (e.g. 3-19 cores).

Thus, generally, each such initial optical package (e.g. multicore fiber) has a plurality of M (M≥3) optical guiding units (cores) within a common cladding of a cross-sectional dimension/diameter a.

In some embodiments, all the M cores in the multicore fiber are so-called “passive cores”, and in some other embodiments at least some (one or more) of the M cores of one or more of the N multicore fibers is/are doped, i.e., P cores are doped (P≤M)—optional step 14. If the multicore fiber includes passive and doped cores, they are arranged in a certain pattern. Generally, the N multicore fibers can have similar or different number/pattern of passive and doped cores.

Then, the N multicore fibers are bundled (step 16) into a bundle of a lateral dimension b, where b>>a. The bundling of the N multicore fibers can be carried out by any known suitable technique, e.g., using a capillary or a holder (e.g., ring-shaped holder) or any other technique for firmly holding the plurality of multicore fibers together.

The so-obtained b-size multicore fiber bundle then undergoes a treatment technique (step 18) aimed at compressing the bundle into a multicore fiber of a size c, which is significantly smaller than size b and may be closer to the original size a of the initial multicore fiber. Such treatment may include heating and/or tapering the bundle. This treatment results in a new multicore fiber (MCF) of smaller size c (as compared to the bundle's size b) including N×M cores (step 20).

It should be noted that the above-described treatment process may include arc heating for fiber tapering. The controlled process parameters include arc power and drawing rate (e.g. about 0.05 mm\sec). An alternative suitable method is the burner method, where the fiber bundle is heated to about 1600-1800 C.

In case the initial multicore fiber has a pattern formed by passive and doped cores, the resulting multicore fiber includes a multiplication of said pattern.

When required, the above process (steps 12-18) can be repeated by applying these steps to several c-size N×M-cores fibers (constituting new initial packages). More specifically, a plurality of these c-size multicore fibers are bundled and then again treated (heated and stretched). Regarding the size (cladding diameter) of the final new multicore fiber, it should be understood that each stage involves a tapering with ratio about 3-10, thus resulting in a relatively small size of the final high core count multicore fiber.

It should be understood that the principles of the technique of the present disclosure are limited neither to the number of fibers (packages) being bundled nor to the number of cores (optical guiding units) in each fiber. Also, the technique of the present disclosure is not limited to a number of repetitions of the bundling and treatment stages. Generally, the number of repetitions depends on the size of the initial multicore fiber used.

The overall process parameters are chosen to provide the desired final core size (diameter), e.g. of about 3-10 microns, and to provide the desired final cladding size (diameter), e.g. at least 50 microns.

Considering commercially available multicore fibers, the typical dimensions may be as follows: For a multicore fiber with passive cores: a core diameter of 10 microns, core spacing of 50 microns, and cladding diameter of 125 microns; for a multicore fiber with doped cores (Er/Yb doped): a core diameter of 6 microns, core spacing of 35 microns, and cladding diameter of 187.5 microns.

As described above, another option is to start the process from an initial package/bundle of glass tubes (optical guiding units), held together by a capillary or a specially built holder.

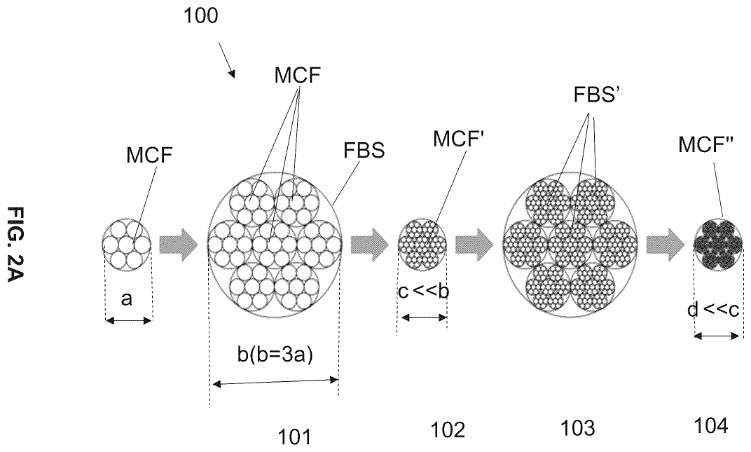

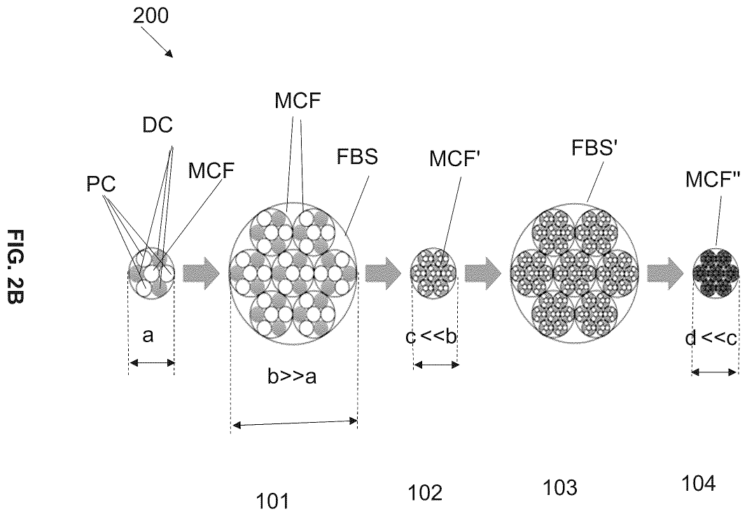

Reference is made to FIGS. 2A and 2B schematically illustrating specific but non-limiting examples of the above-described technique of the present disclosure.

FIG. 2A exemplifies a process 100 for fabricating a multicore fiber of complex geometry. As shown in FIG. 2A, a plurality of N (N=7) initial multicore fibers MCF (packages of optical guiding units) each having M cores (M=7) and having a lateral dimension (cladding diameter) a, are bundled (step 101), with or without a capillary, into a fiber bundle structure FBS of a lateral dimension b (b>>a). The bundled MCFs structure FBS is then treated (e.g., heated and/or tapered) to compress this structure FBS and thus create another (new) multicore fiber MCF′ (step 102) having a lateral dimension c which is significantly smaller than size b and has 7×7 (N×M) cores.

As shown in this non-limiting examples, the above process is repeated: A new plurality of K multicore fibers MCF′ (K may be equal or different to N)−7 such new multicore fibers MCF′ in the present examples—are bundled into a new bundle structure FBS' (step 103) and then treated/compressed e.g. via heating and tapering (step 104) resulting in a new multicore fiber MCF″ of size d with (N×M×K) cores.

The example of FIG. 2B schematically illustrates the process 200 for fabricating a multicore fiber of complex geometry having a pattern of doped cores. The process 200 is generally similar to the above-described example of FIG. 2A. However in the example of FIG. 2B the process starts from provision of a plurality of N (e.g. N=7) initial multicore fibers MCF with heterogenous composition cores, i.e. the multicore fiber includes a pattern of passive cores PC (e.g., silica cores) and doped cores DC (e.g., Er/Yb-doped). The initial multicore fibers MCF, each of size a, are bundled (step 101) into a fiber bundle structure FBS of a size b (b>>a); structure FBS is treated (e.g., heated and/or tapered) to create a new multicore fiber MCF′ (step 102) of smaller size c and increased number 7×7 (N×M) of cores. Optionally. a new plurality of K multicore fibers MCF′ is bundled into a new bundle structure FBS' (step 103) and treated (step 104) resulting in a new multicore fiber MCF″ of size d with (N×M×K) cores. The technique of the present disclosure enables controlled doping of selected cores at the initial stage only and maintain it during the process of fabricating the resulting multicore fiber MCF′ (or MCF″).

1. A method of fabricating a multi-core fiber having a complex geometry, the method comprising:
providing a plurality of N initial optical packages, each optical package having an initial cross-sectional dimension a and including a predetermined number M of optical guiding units;
bundling said plurality of N optical packages into a bundle structure;
applying a heating-based treatment to said bundle structure to obtain a new multicore fiber having a cross-sectional dimension c being equal or smaller than the initial cross-sectional dimension a and including a number N×M cores.

2. The method according to claim 1, wherein the initial optical package is a bundle including the predetermined number M of glass tubes.

3. The method according to claim 1, wherein the initial optical package is a bundle including the predetermined number M of the polymer fibers.

4. The method according to claim 1, wherein the initial optical package is a bundle including the predetermined number M of polymer fibers and glass tubes.

5. The method according to claim 1, wherein the initial optical package is an initial multicore fiber including the predetermined number M of cores.

6. The method according to claim 5, wherein said multicore fiber is a single-mode or multi-mode multicore fiber.

7. The method according to claim 1, further comprising: performing at least one repetition of successively performed processes of the bundling and the heating-based treatment to a new plurality of a number K of said new multicore core fibers, thereby obtaining a successive new multicore fiber including N×M×K cores.

8. The method according to claim 1, wherein the initial optical package has one of the following configurations: is a bundle of glass tubes including the predetermined number M of glass tubes; is a bundle of polymer fibers including the predetermined number M of the polymer fibers; is a bundle of the predetermined number M of polymer fibers and glass tubes; and is an initial multicore fiber including the predetermined number M of cores.

9. The method according to claim 8, further comprising: performing at least one repetition of successively performed processes of the bundling and the heating-based treatment to a new plurality of a number K of said new multicore core fibers, thereby obtaining a successive new multicore fiber including N×M×K cores.

10. The method according to claim 5, wherein said plurality of N initial multicore fibers comprises one or more multicore fiber comprising doped cores.

11. The method according to claim 5, wherein said plurality of N initial multicore fibers comprises one or more multicore fiber comprising a pattern of passive and doped cores.

12. The method according to claim 5, wherein the multicore fibers are fused into a multi-mode region.

13. A multicore fiber manufactured by the method of claim 1.

14. A multicore fiber manufactured by the method of claim 9.

15. A multicore fiber comprising at least 15 cores within a common cladding of a cross-sectional dimension of at least 50 microns.

16. The multicore fiber according to claim 15, wherein said cores comprise doped cores.

17. The multicore fiber according to claim 15, said cores comprise passive and doped cores.

18. A device comprising at least one multicore fiber configured according to claim 15.

19. The multicore fiber according to claim 13, comprising at least 15 cores within a common cladding of a cross-sectional dimension of at least 50 microns, said cores comprising cores of at one of passive and doped types.

20. The multicore fiber according to claim 14, comprising at least 15 cores within a common cladding of a cross-sectional dimension of at least 50 microns, said cores comprising cores of at one of passive and doped types.

21. A device comprising at least one multicore fiber configured according to claim 13.
